(19) United States
(12) Patent Application Publication
(10) Pub. No.: US 2018/0372136 A1
(43) Pub. Date: Dec. 27, 2018

(54) CONNECTION STRUCTURE FOR STORAGE SHELF

(71) Applicant: WIRE MASTER INDUSTRY CO., LTD., Changhua Hsien (TW)

(72) Inventor: Hsi-Ming CHENG, Changhua Hsien (TW)

(21) Appl. No.: 15/630,191

(22) Filed: Jun. 22, 2017

(51) Int. Cl. F16B 12/02; A47B 47/00; A47B 96/02

(52) U.S. Cl. CPC F16B 12/02; A47B 96/024; A47B 47/0083

(57) ABSTRACT

A connection structure for a storage shelf, the storage shelf contains four posts fitting with plural support plates respectively by using multiple plastic fitting elements, and each support plate includes a metal sheet and a fixing frame. The fixing frame has four fitting sleeves fitted with the four posts individually by using the multiple plastic fitting elements. A first peripheral tab and a second peripheral tab extend inwardly from an inner wall of the fixing frame, and the first peripheral tab is located above the second peripheral tab. The fixing frame has four first grooves, and the fixing frame also has four second grooves. Each fitting sleeve has plural first vertical ribs surrounding an outer wall thereof and corresponding to the first peripheral tab, and each fitting sleeve has plural second vertical ribs surrounding the outer wall of each fitting sleeve and corresponding to the second peripheral tab.

### FIELD OF THE INVENTION

The present invention relates to a connection structure for a storage shelf in which each fixing frame and each fitting sleeve are securely connected together.

### BACKGROUND OF THE INVENTION

With reference to FIGS. 1 and 2, a conventional storage shelf contains at least four posts 10, and between any two adjacent of the at least four posts 10 are defined multiple recesses 11 so as to fit with two plastic fitting elements 12, 13. Each of the two plastic fitting elements 12, 13 has a rib 14 retaining with each of the multiple recesses 11. Each of the two plastic fitting elements 12, 13 is conical, and four fitting sleeves 21 are arranged on four corners of each of plural support plates 20 respectively, wherein each of the four fitting sleeves 21 is conical so as to mate with the two plastic fitting elements 12, 13, thus connecting each support plate 20 and the at least four posts 10 together. In addition, each support plate 20 has multiple metal bars welded together so as to form a grid holding face 22, and a fixing frame 23 of each support plate 20 is made of metal rods mating with a plurality of welding bars so as to reinforce the storage shelf and store objects.

Alternatively, the grid holding face is replaced by a metal mesh sheet so as to avoid objects dropping out of gaps of the grid holding face.

Each support plate and the at least four posts are connected together by welding the four fitting sleeves with the at least four posts, so four grooves or four notches are arranged on the four corners of each support plate so that after each fitting sleeve abuts against each of the four grooves or notches, welding flux is applied to weld each fitting sleeve and each groove or notch together, thus connecting each support plate and each fitting sleeve together. After each fitting sleeve is fitted with the at least four posts, the two plastic fitting elements fix each fitting sleeve and the at least four posts, wherein a position of each of the two plastic fitting elements is adjustable so as to adjust a distance between any two adjacent support plates.

However, welding traces occur among the fixing frame and the four fitting sleeves to have poor appearance and to influence welding quality.

The present invention has arisen to mitigate and/or obviate the afore-described disadvantages.

### SUMMARY OF THE INVENTION

The primary objective of the present invention is to provide a connection structure for a storage shelf in which each fixing frame and each fitting sleeve are securely connected together.

Another objective of the present invention is to provide a connection structure for a storage shelf which obtains stable connection, avoids using cost of welding flux, accelerates production time, and achieve aesthetic appearance.

To obtain the above objectives, a connection structure for a storage shelf provided by the present invention, the storage shelf contains at least four posts fitting with a plurality of support plates respectively by way of multiple plastic fitting elements, and each of the plurality of support plates includes a metal sheet and a fixing frame which are connected together, the fixing frame has four fitting sleeves arranged on four corners of the fixing frame respectively and fitted with the at least four posts of the storage shelf individually by way of the multiple plastic fitting elements.

A first peripheral tab and a second peripheral tab extend inwardly from an inner wall of the fixing frame, and the first peripheral tab is located above the second peripheral tab, the fixing frame has four first grooves respectively defined on four corners of the first peripheral tab thereof, and the fixing frame also has four second grooves individually formed on four corners of the second peripheral tab thereof.

Each of the four fitting sleeves has plural first vertical ribs surrounding an outer wall thereof, and each fitting sleeve also has plural second vertical ribs surrounding the outer wall of each fitting sleeve, hence each fitting sleeve is fitted in each of the four first grooves of the first peripheral tab and in each second groove of the second peripheral tab, the plural first vertical ribs and the plural second vertical ribs contact with the first peripheral tab and the second peripheral tab respectively, and each fitting sleeve is connected with the fixing frame in a high frequency welding manner.

In assembly, each fitting sleeve is fitted in each first groove of the first peripheral tab and each second groove of the second peripheral tab, and the plural first vertical ribs and the plural second vertical ribs contact with the multiple first bosses and the multiple second bosses respectively so that the multiple first bosses and the multiple second bosses are connected with the plural first vertical ribs and the plural second vertical ribs individually in a high frequency welding manner, thus connecting each fixing frame and each fitting sleeve together securely.

Preferably, each fitting sleeve is fitted in each first groove and each second groove of each fixing frame of each support plate so as to be covered by each fixing frame in the high frequency welding manner, thus obtaining stable connection, avoiding using cost of welding flux, accelerating production time, and achieving aesthetic appearance. Preferably, each fitting sleeve is connected with each fixing frame securely.

### BRIEF DESCRIPTION OF THE DRAWINGS

FIG. 1 is a perspective view of a conventional storage shelf.

FIG. 2 is a perspective view showing the exploded components of a part of the conventional storage shelf.

FIG. 3 is a perspective view showing the exploded components of a support plate and four fitting sleeves of a connection structure for a storage shelf according to a preferred embodiment of the present invention.

FIG. 4 is a perspective view showing the exploded components of a part of the support plate and one of the four fitting sleeves of the connection structure for the storage shelf according to the preferred embodiment of the present invention.

FIG. 5 is a perspective view showing the assembly of one fitting sleeve of the connection structure for the storage shelf according to the preferred embodiment of the present invention.

FIG. 6 is a perspective view showing the operation of a part of a fixing frame and the one fitting sleeve of the connection structure for the storage shelf according to the preferred embodiment of the present invention.

FIG. 7 is another perspective view showing the operation of a part of the fixing frame and the one fitting sleeve of the connection structure for the storage shelf according to the preferred embodiment of the present invention.

FIG. 8 is a cross sectional view showing the assembly of a part of the fixing frame and the one fitting sleeve of the connection structure for the storage shelf according to the preferred embodiment of the present invention.

FIG. 9 is a perspective view showing the assembly of a support plate and four fitting sleeves of the connection structure for the storage shelf according to the preferred embodiment of the present invention.

FIG. 10 is a perspective view showing the assembly of the storage shelf according to the preferred embodiment of the present invention.

FIG. 11 is a perspective view showing the exploded components of a fitting sleeve and a fixing frame of a connection structure for a storage shelf according to another preferred embodiment of the present invention.

FIG. 12 is a perspective view showing the exploded components of a fitting sleeve and a fixing frame of a connection structure for a storage shelf according to another preferred embodiment of the present invention.

FIG. 13 is a perspective view showing the exploded components of a fitting sleeve and a fixing frame of a connection structure for a storage shelf according to another preferred embodiment of the present invention.

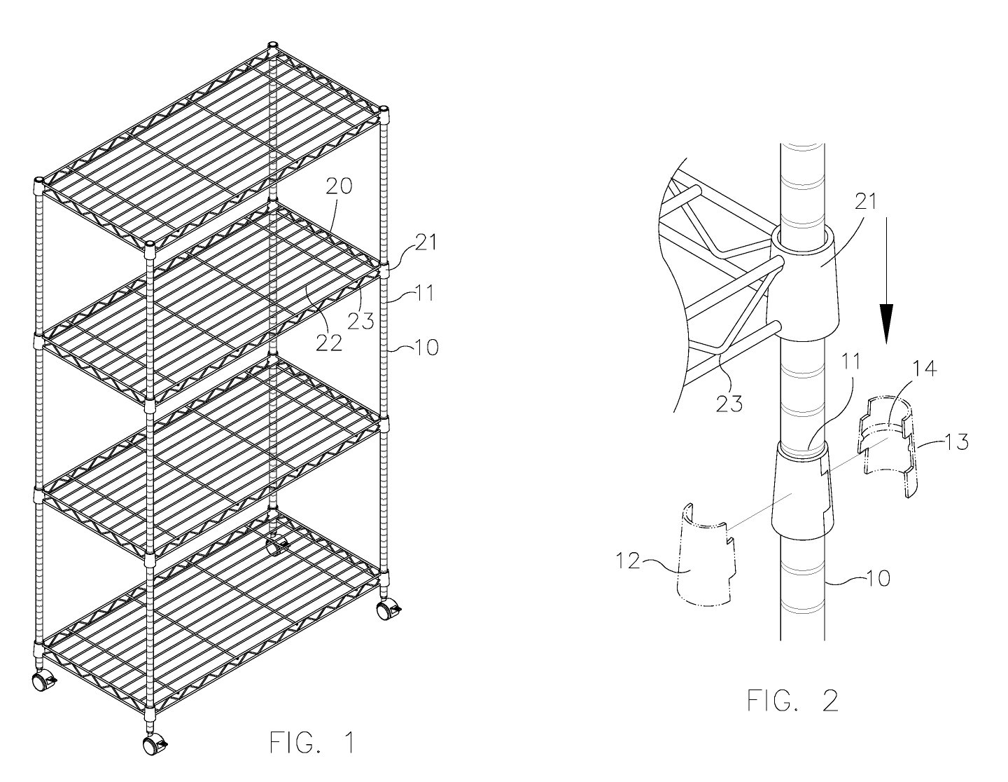

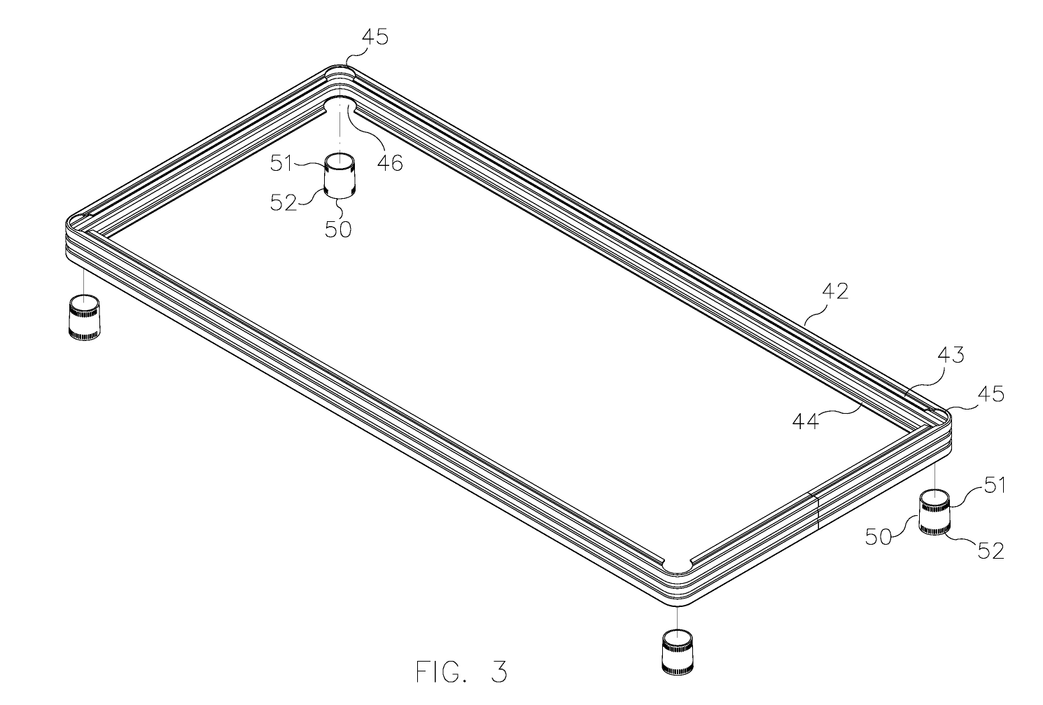

### DETAILED DESCRIPTION OF THE PREFERRED EMBODIMENTS

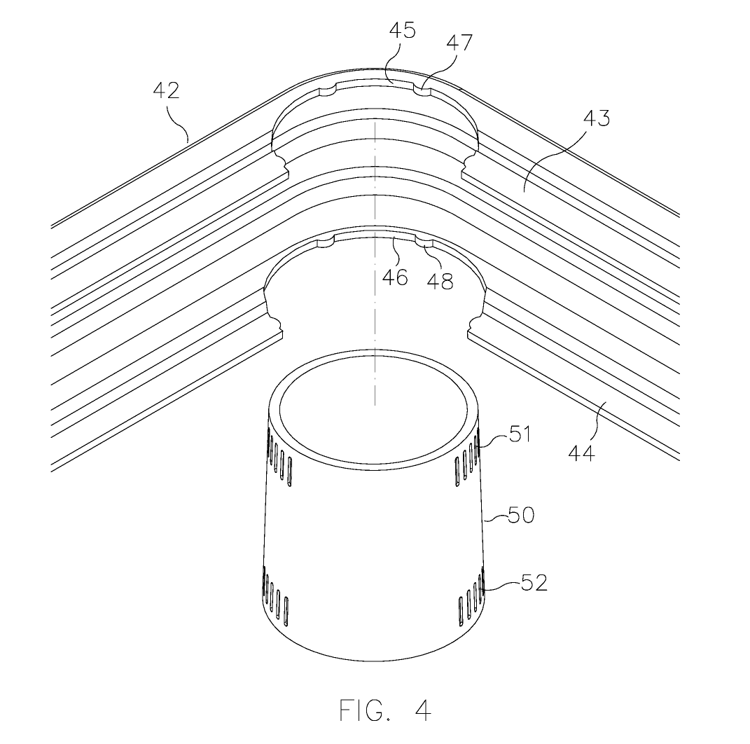

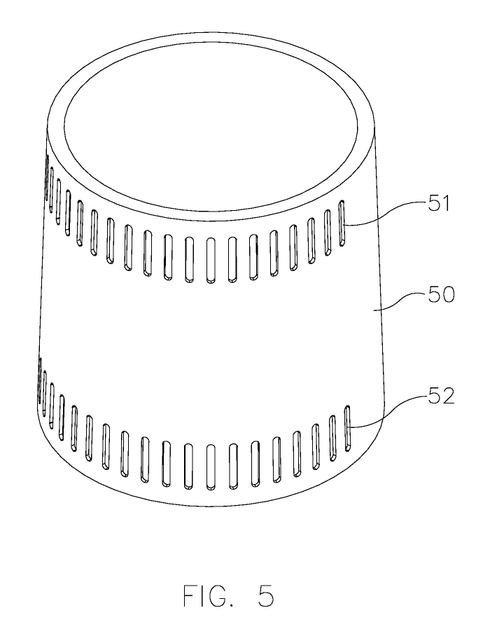

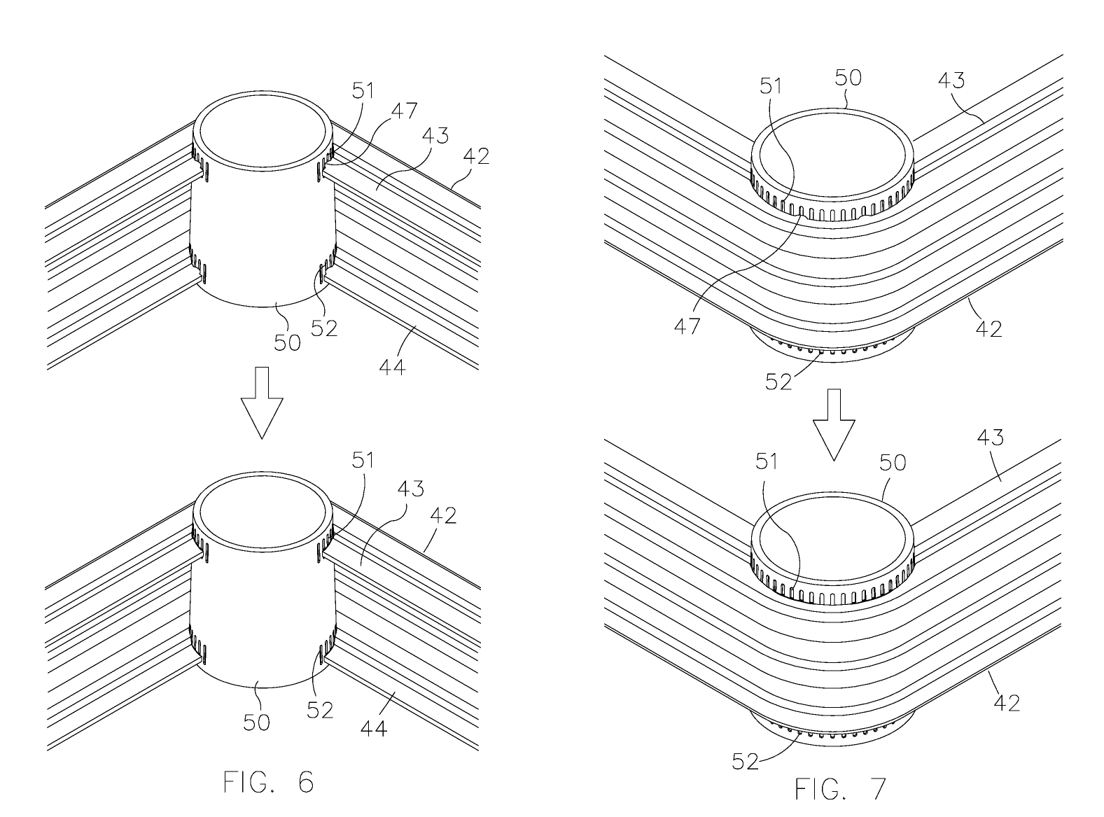

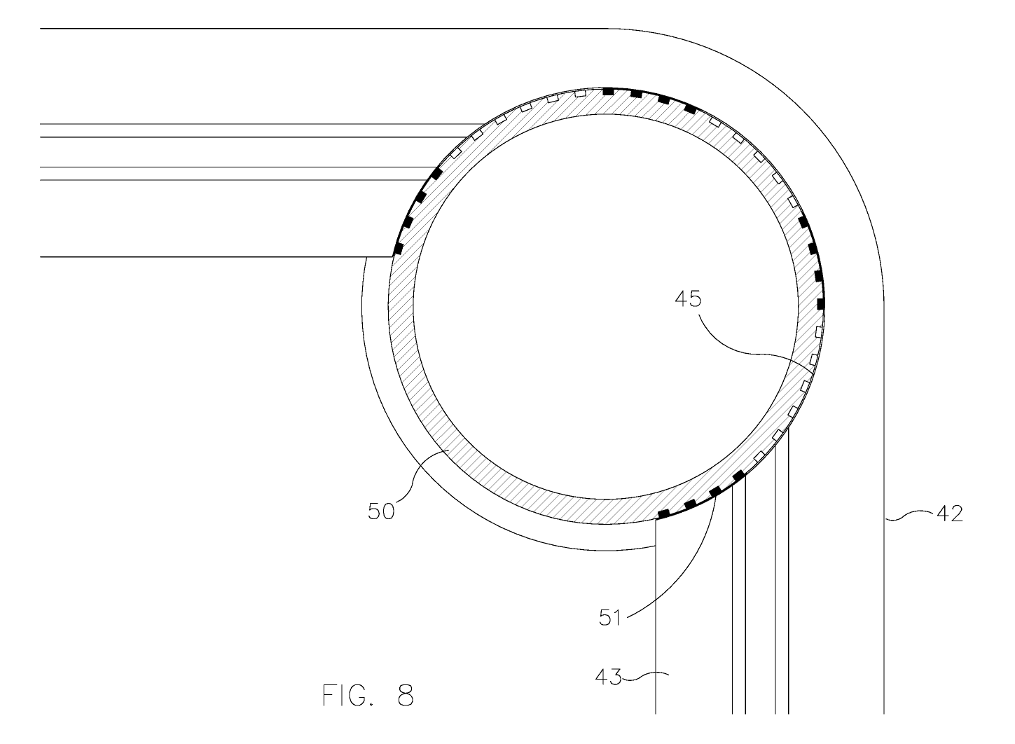

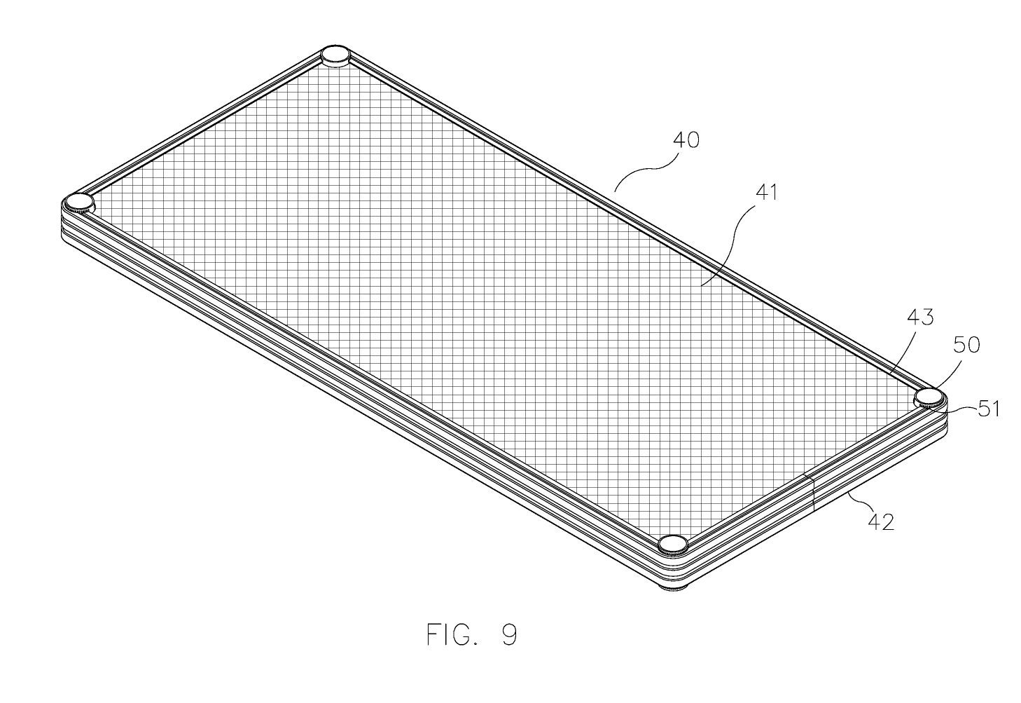

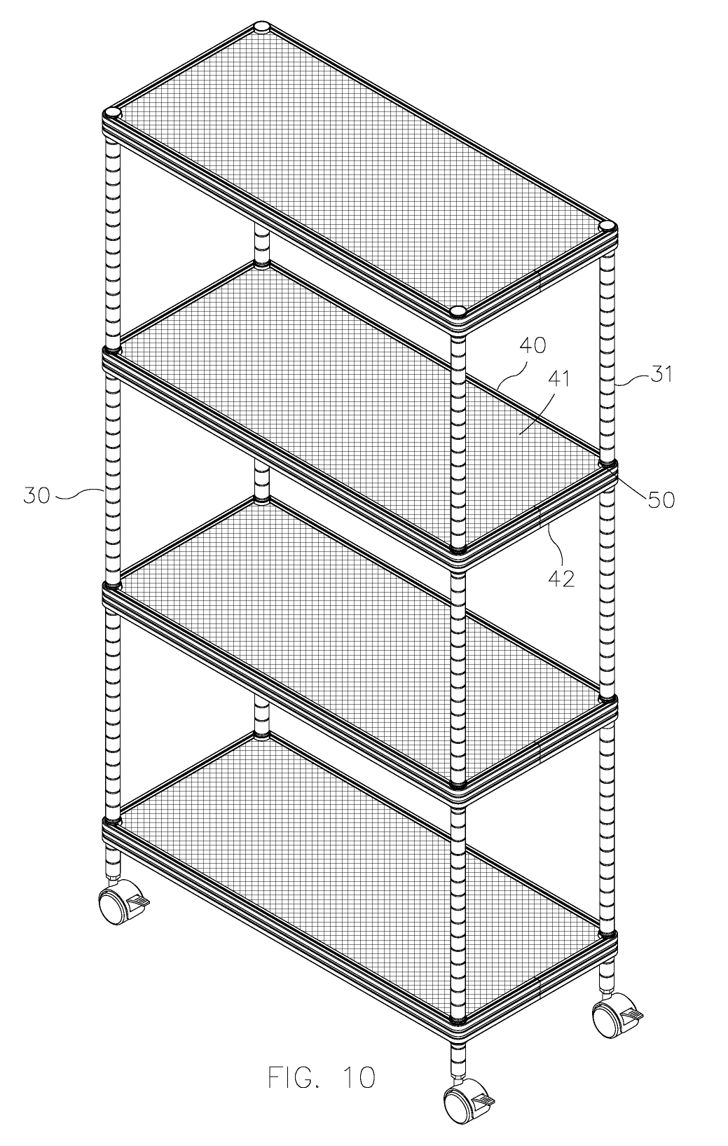

With reference to FIGS. 3 to 13, a connection structure for a storage shelf according to a preferred embodiment of the present invention comprises: multiple metal sheets 41 and multiple fixing frames 42 which are connected together so as to form a plurality of support plates 40 of the storage shelf 30, wherein each of the multiple fixing frames 42 has four fitting sleeves 50 arranged on four corners of each fixing frame 42 respectively and fitted with four posts 32 of the storage shelf 30 individually by way of four plastic fitting elements 32, thus assembling the storage shelf 30.

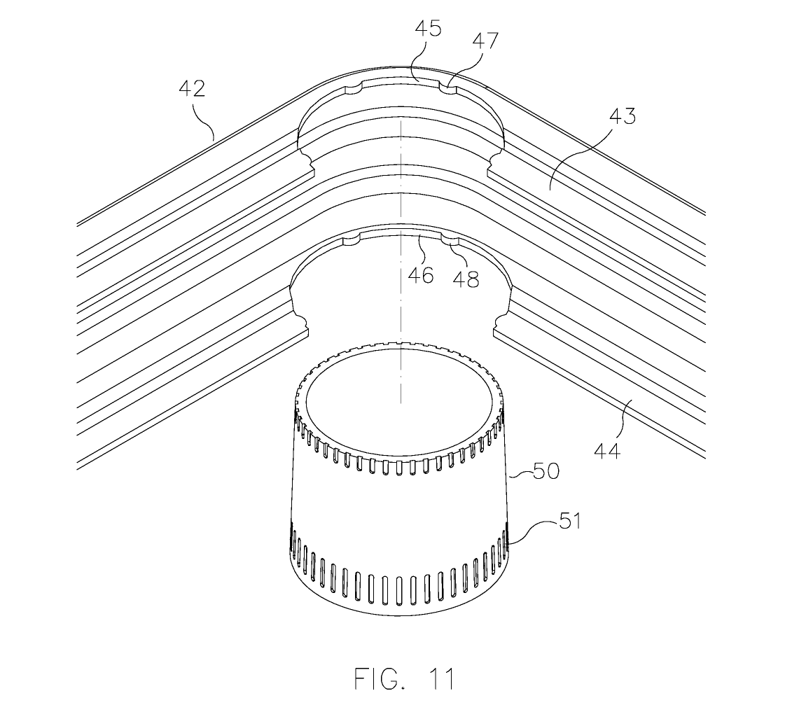

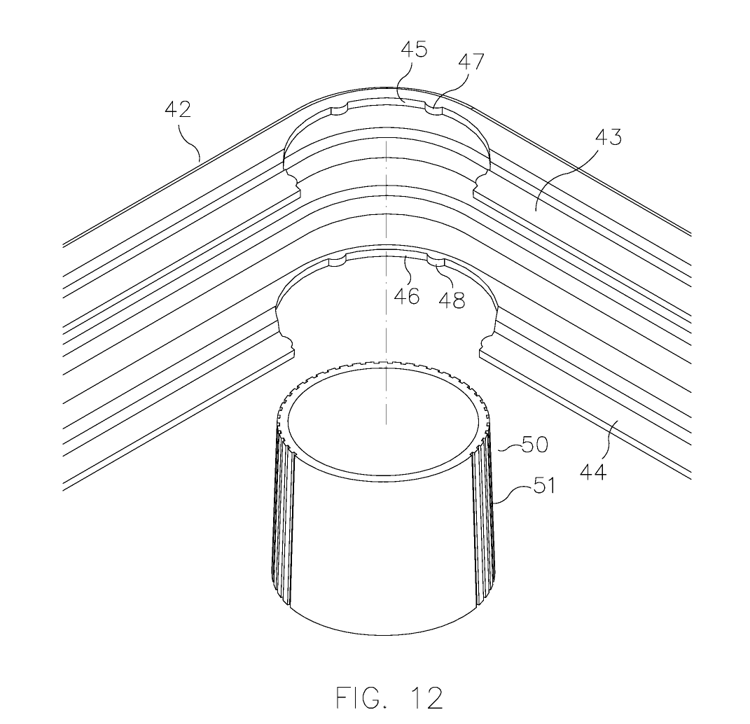

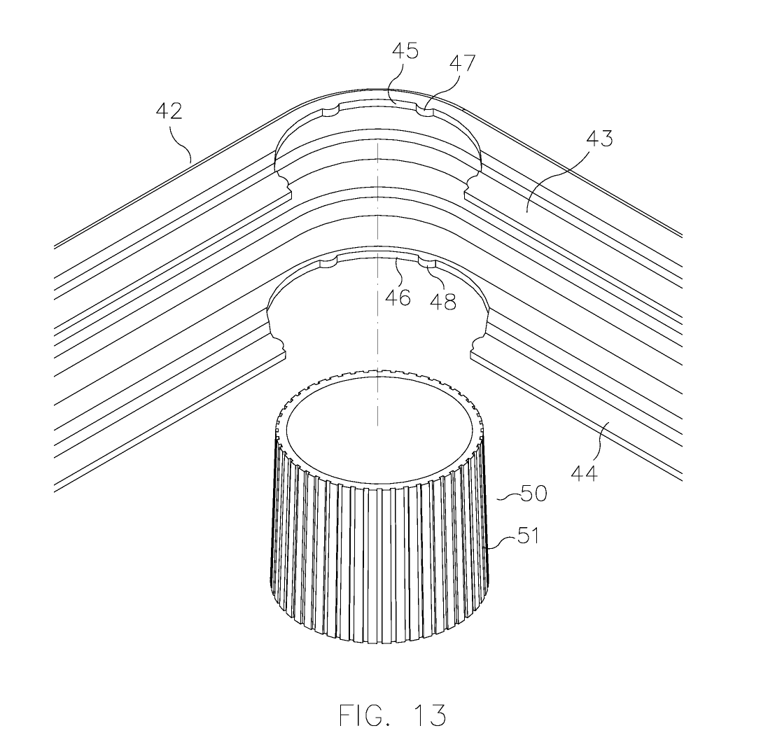

As connecting each of the plurality of support plates 40 with each of the four fitting sleeves 50, a first peripheral tab 43 and a second peripheral tab 44 extend inwardly from an inner wall of each fixing frame 42, wherein the first peripheral tab 43 is located above the second peripheral tab 44 and is connected with each of the multiple metal sheets 41, and the second peripheral tab 44 supports each metal sheet 41 stably. Each fixing frame 42 has four first grooves 45 respectively defined on four corners of the first peripheral tab 43 thereof, and each fixing frame 42 also has four second grooves 46 individually formed on four corners of the second peripheral tab 44 thereof, hence each fitting sleeve 50 fits in each of the four first grooves 45 and each of the four second grooves 46. Each fitting sleeve 50 is conical (i.e., a diameter of a top of each fitting sleeve 50 is less than that of a bottom of each fitting sleeve 50), and a diameter of each first groove 45 of the first peripheral tab 43 is less than each second groove 46 of the second peripheral tab 44 so that each first groove 45 and each second groove 46 fit with each fitting sleeve 50. Each first groove 45 has multiple first bosses 47 arranged on an inner wall thereof, and each second groove 46 has multiple second bosses 48 arranged on an inner wall thereof. Each fitting sleeve 50 has plural first vertical ribs 51 partially or completely surrounding an outer wall thereof horizontally and corresponding to the first peripheral tab 43, and each fitting sleeve 50 also has plural second vertical ribs 52 partially or completely surrounding the outer wall of each fitting sleeve 50 horizontally and corresponding to the second peripheral tab 44, as shown in FIGS. 3 and 11. Alternatively, the plural first vertical ribs 51 partially or completely surround the outer wall of each fitting sleeve 50 vertically, as illustrated in FIGS. 12 and 13. A configuration range of the plural first vertical ribs 51 is equal to a perimeter of each first groove 45, and a configuration range of the plural second vertical ribs 52 is equal to a perimeter of each second groove 46, hence each fitting sleeve 50 fits in each first groove 45 of the first peripheral tab 43 and each second groove 46 of the second peripheral tab 44. In assembly, each fitting sleeve 50 is fitted in each first groove 45 of the first peripheral tab 43 and each second groove 46 of the second peripheral tab 44, and the plural first vertical ribs 51 and the plural second vertical ribs 52 contact with the multiple first bosses 47 and the multiple second bosses 48 respectively so that the multiple first bosses 47 and the multiple second bosses 48 are connected with the plural first vertical ribs 51 and the plural second vertical ribs 52 individually in a high frequency welding manner, thus connecting each fixing frame 42 and each fitting sleeve 50 together securely.

Preferably, each fitting sleeve 50 is fitted in each first groove 45 and each second groove 46 of each fixing frame 42 of each support plate 40 so as to be covered by each fixing frame 42 in the high frequency welding manner, thus obtaining stable connection, avoiding using cost of welding flux, accelerating production time, and achieving aesthetic appearance. Preferably, each fitting sleeve 50 is connected with each fixing frame 42 securely.

When connecting each fixing frame and each fitting sleeve together, each fitting sleeve is fitted in each first groove and each second groove of each fixing frame, and the multiple first bosses and the multiple second bosses are connected with the plural first vertical ribs and the plural second vertical ribs individually in the high frequency welding manner, thus connecting each fixing frame and each fitting sleeve together securely.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A connection structure for a storage shelf, the storage shelf comprising at least four posts fitting with a plurality of support plates respectively by way of multiple plastic fitting elements, and each of the plurality of support plates including a metal sheet and a fixing frame which are connected together, the fixing frame having four fitting sleeves arranged on four corners of the fixing frame respectively and fitted with the at least four posts of the storage shelf individually by way of the multiple plastic fitting elements;
wherein a first peripheral tab and a second peripheral tab extend inwardly from an inner wall of the fixing frame, and the first peripheral tab is located above the second peripheral tab, the fixing frame has four first grooves respectively defined on four corners of the first peripheral tab thereof, and the fixing frame also has four second grooves individually formed on four corners of the second peripheral tab thereof;
wherein each of the four fitting sleeves has plural first vertical ribs surrounding an outer wall thereof, and each fitting sleeve also has plural second vertical ribs surrounding the outer wall of each fitting sleeve, hence each fitting sleeve is fitted in each of the four first grooves of the first peripheral tab and in each second groove of the second peripheral tab, the plural first vertical ribs and the plural second vertical ribs contact with the first peripheral tab and the second peripheral tab respectively, and each fitting sleeve is connected with the fixing frame in a high frequency welding manner.

2. The connection structure as claimed in claim 1, wherein the plural first vertical ribs of each fitting sleeve correspond to the first peripheral tab of the fixing frame, and the plural second vertical ribs of each fitting sleeve correspond to the second peripheral tab of the fixing frame.

3. The connection structure as claimed in claim 1, wherein the plural first vertical ribs of each fitting sleeve surround the outer wall of each fitting sleeve vertically and corresponding to the first peripheral tab, and the plural second vertical ribs of each fitting sleeve surround the outer wall of each fitting sleeve horizontally and corresponding to the second peripheral tab.

4. The connection structure as claimed in claim 1, wherein a configuration range of the plural first vertical ribs is equal to a perimeter of each first groove, and a configuration range of the plural second vertical ribs is equal to a perimeter of each second groove.

5. The connection structure as claimed in claim 1, wherein the plural first vertical ribs of each fitting sleeve completely surround the outer wall thereof each fitting sleeve, and the plural second vertical ribs of each fitting sleeve completely surround the outer wall thereof each fitting sleeve.

6. The connection structure as claimed in claim 1, wherein the plural first vertical ribs of each fitting sleeve surround the outer wall of each fitting sleeve vertically.

7. The connection structure as claimed in claim 1, wherein each first groove has multiple first bosses arranged on an inner wall thereof, and each second groove has multiple second bosses arranged on an inner wall thereof, and the multiple first bosses and the multiple second bosses contact with the outer wall of each fitting sleeve.
